(19) United States
(12) Patent Application Publication
(10) Pub. No.: US 2008/0154740 A1
(43) Pub. Date: Jun. 26, 2008

(54) Apparatuses, Methods and Systems for Electronic Real Estate Transactions

(76) Inventor: Chun-Kyoung Lee, Seoul (KR)

Correspondence Address: CHADBOURNE & PARKE LLP, 30 ROCKEFELLER PLAZA, NEW YORK, NY, 10112, US

(21) Appl. No.: 11/757,897

(22) Filed: Jun. 4, 2007

Related U.S. Application Data
(60) Provisional application No. 60/804,300, filed on Jun. 9, 2006.

(51) Int. Cl. G06Q 30/00; G06Q 20/00

(52) U.S. Cl. 705/26

(57) ABSTRACT

The disclosure details the implementation of an apparatuses, methods, and systems for Electronic Real Estate Transactions. In one embodiment, the disclosure details a method for providing commercial transaction services of virtual real estate using a digital map. The system creates a digital map including general Points of Interest information. The system may then insert information on non-transaction regions including specific topographical features and public facilities. The system allows users to enter into a transaction and/or otherwise administer the virtual real estate by using the digital map on their computer terminal.

### RELATED APPLICATIONS

This disclosure claims priority to under 35 U.S.C. § 119 and incorporates by reference U.S. Provisional Patent Application Ser. No. 60/804,300, titled “Apparatuses, Methods and Systems for Electronic Real Estate Transactions” filed Jun. 9, 2006.

### FIELD

The present invention is directed generally to an apparatuses, methods, and systems of electronic transactions, and more particularly, to apparatuses, methods and systems for virtual real estate transactions.

### BACKGROUND

With the spread of a high-speed internet network, and various wire and wireless terminals, electronic commercial transaction services have been frequently provided through the internet. The internet is now composed of computer communication networks capable of connecting the entire world, and can transmit information between various networks having various technologies and devices using a common protocol (e.g., TCP/IP).

With the spread of the internet, and the growing popularity of the World Wide Web, various electronic map services have become available such as those found at MapQuest.com. Some internet-based businesses have appeared offering services such as giving directions on the basis of a digital map or a satellite map.

### SUMMARY

Current electronic transaction systems do not provide a straightforward, unified, and transparent interface for interacting and making purchases. As more and more information is placed on the web, the conventional method of online transactions of real state remain indirect, still largely in the domain of brokered deals by agents. Direct transactions between owner and buyer have been stifled because the legal framework of the real estate transaction must still be ensured through verification of sales objects, inspection of legal documents, and direct contracts completed with personal interaction. Digital maps have been relegated to merely informing real estate brokers of surrounding areas of real estate, environmental inspections and local market prices. Conventionally, it is difficult for owners and the buyers to directly execute a sales contract or a lease contract online via the internet.

In one embodiment, the disclosure teaches a method for providing commercial transaction service of virtual real estate that enables users to purchase virtual real estate via users' terminals by means of performing an estimate. This estimate will be automatically generated according to a predetermined unit price, when the user selects a desired region and property size, using a digital map on which general point of interest (POI) information, except public information, is deleted. Further, information on non-transaction areas is inserted including specific topographical features and public facilities, and that enables the user to sell or advertise real estate using the map.

In another embodiment, the disclosure teaches a computer-readable recording media, where an program executable on a computer is recorded, that enables a user to purchase virtual real estate by means of performing an estimate automatically according to a predetermined unit price, when the user selects a desired region and property size, using a digital map on which general point of interest (POI) information, except public information, is deleted, and information on non-transaction regions is inserted including specific topographical features and public facilities, and that enables the user to sell or advertise the real estate using the map.

In another embodiment, the disclosure teaches a method for providing commercial transaction services of virtual real estate by connecting at least one operator computer, a server computer for controlling a digital map and a communication transaction, and at least one user terminal, through a communication network, comprising: storing a program, in which a regional division technique is encoded on a digital map for sales of virtual real estate, in the server computer; storing information on which sales price tables according to regions and property sizes of virtual real states are coded, information on a technique for estimating a price according to a property size and information on non-transaction regions, in the server computer; outputting a geographic information system (GIS) digital map and selecting the digital map according to layers representing the area in reduced scale; deleting general point of interest (POI) information, except public information, from information displayed on the layer, and inserting information on non-transaction regions including specific topographical features and public facilities into digital map data; creating a digital map and storing the created digital map in the server computer, by repeatedly executing the process for deleting the general POI information according to respective layers and inserting the information on non-transaction regions into the digital map data; and performing a transaction or administration of virtual real estate to be performed, on the basis of the digital map, by means of the server computer, through the user terminal.

In another embodiment, the disclosure teaches performing a transaction or administration of virtual real estate, which may include: (a) selecting a desired region and a property size on the digital map through the user terminal; (b) enabling the server computer to determine whether an owner exists for the selected region; (c) displaying the property size and sales price of the selected region on the user terminal, if the owner does not exist, transmitting the sales price and payment technique to the user terminal, if a purchase of the virtual real estate, corresponding to the selected region, is selected through the user terminal, and enabling the server computer to change and store ownership information of the virtual real estate, if it is verified that the purchasing price of the virtual real estate is paid; (d) transmitting a purchase decision message, for which terms and conditions are prescribed, to the owner's terminal, if the owner exists for the selected region, and enabling the server computer to change and store the ownership information of the virtual real estate, if the owner agrees to the terms and conditions sent from a buyer who desires to purchase the property and it is verified that a sales price prescribed in a transfer agreement is paid.

In item (c), it may include: determining whether the selected region is a non-transaction region and a minimum sales unit region, if the owner does not exist; if the selected region is a non-transaction region or below the minimum sales unit, selecting a region and a property size again; displaying the property size and the sales price of the selected region on the user terminal, if the selected region is not a non-transaction region and above the minimum sales unit, and transmitting the sales price and the payment technique to the user terminal, if the purchase of the virtual real estate, corresponding to the selected region, is selected through the user terminal; and enabling the server computer to change and store the ownership information of the virtual real estate, if it is verified that the purchasing price of the virtual real estate is paid. If the payment for buying the virtual real estate is not performed, an ability to select a region and a property size again may be further included.

The item (d), it may include: transmitting a purchase decision message, for which terms and conditions are prescribed, to the owner's terminal, if the owner exists for the selected region; transmitting a new message for terms and conditions to a terminal of a buyer who desires to purchase the property, if the owner does not agree to the terms and conditions; transmitting a transfer agreement to the buyer's terminal and the server computer, if the owner agrees to the terms and conditions; and if it is verified that the sales amount of money prescribed in the transfer agreement is paid, notifying the owner's terminal and the buyer's terminal of the payment, respectively, enabling an amount of money, except pre-specified sales commissions, to be sent to an account or with a payment technique that the owner desires, enabling the server computer to change and store ownership information of the virtual real estate, and notifying the buyer of changed contents of the ownership information.

In another embodiment, the disclosure, further, teaches: notifying the owner's terminal and the buyer's terminal of the nonpayment, if it is not verified that the buyer sends the amount of money, even after the regular time has be passed since the transfer agreement is received from the owner; and stopping the transaction, according to the owner's desire, if there is nonpayment, and transmitting information on the buyer as feedback information on bad buyer for tracking community input on historical transaction experiences to the server computer.

In another embodiment, the disclosure teaches a method providing the commercial transaction services using the digital map may further include editing and storing information on properties, so as to display the text that the user desires, when the user moves a cursor over the virtual real estate by connecting the server computer through the user terminal, if the administration for virtual real estate is desired.

In another embodiment, the disclosure teaches a method providing the commercial transaction services using the digital map may further include outputting a user-specified web page or a blog, when a region on the digital map, on which the virtual real estate is located, is clicked.

In another embodiment, the disclosure teaches a method providing commercial transaction services using the digital map may further include providing a virtual item through the server computer, so as to enable the virtual item to be purchased through the user terminal, for the purpose of enhancing a value of virtual real estate and decorating the real estate for further personalization and enjoyment.

In another embodiment, the disclosure teaches a method providing commercial transaction services using the digital map may further include registering the virtual real estate as real estate for sale in a region where the virtual real estate is located, if the owner of the virtual real estate desires to sell the virtual real estate.

In another embodiment, the disclosure teaches a method for providing commercial transaction services of the virtual real estate by connecting at least one operator computer, a server computer for controlling a digital map and a communication transaction, and at least one user terminal, through the communication network, comprising: (a) providing to the server computer a digital map on which general POI information, except public information, is deleted, and information on non-transaction regions including specific topographical features and public facilities is inserted; (b) selecting a desired region and a property size on the digital map through the user terminal; (c) enabling the server computer to determine whether an owner exists for the selected region; (d) displaying the property size and sales price of the selected region on the user terminal, if the owner does not exist, transmitting the sales price and payment technique to the user terminal, if a purchase of the virtual real estate corresponding to the selected region is selected through the user terminal, and enabling the server computer to change and store ownership information on the virtual real estate, if it is verified that the purchasing price of the virtual real estate is paid; and (e) transmitting a purchase decision message, for which terms and conditions are prescribed, to the owner's terminal, if the owner exists for the selected region, and enabling the server computer to change and store the ownership information of the virtual real estate, if the owner agrees to the terms and conditions sent from a buyer who desires to purchase the properties and it is verified that a sales price prescribed in the transfer agreement is paid.

The item (d), it may include: determining whether the selected region is a non-transaction region and a minimum sales unit region is selected, if the owner does not exist; selecting a region and a property size again, if the selected region is a non-transaction region or below a minimum unit region; displaying the property size and sales price of the selected region on the user terminal, if the region is not a non-transaction region and above the minimum sales unit, and transmitting the sales price and payment technique to the user terminal, if the purchase of the virtual real estate corresponding to the selected region is selected through the user terminal; and enabling the server computer to change and store ownership information of the virtual real estate, if it is verified that the purchasing price of the virtual real estate is paid. It may further include: selecting a region and a property size, if the payment for the purchase of the virtual real estate is not performed.

The item (e), it may include: transmitting a purchase decision message, for which terms and conditions are prescribed, to the owner's terminal, if the owner exists for the selected region; transmitting a new message for terms and conditions to a terminal of a buyer who desires to purchase the property, if the owner does not agree on the terms and conditions; transmitting a transfer agreement to the buyer's terminal and the server computer, if the owner agrees to the terms and conditions; and notifying the owner's terminal and the buyer's terminal of the payment, if it is verified that the sales amount of money prescribed in the transfer agreement is paid, enabling an amount of money, except pre-specified sales commissions, to be sent to an account or with a payment technique that the owner desires, enabling the server computer to change and store ownership information of the virtual real estate, and notifying the buyer of changed contents of the ownership information. The method may further include: notifying the owner's terminal and the buyer's terminal of nonpayment, if it is verified that the buyer does not pay the amount of money, even after the regular time has be passed since the transfer agreement is received from the owner; and stopping the transaction according to the owner's desire, in case of nonpayment, and transmitting information on the buyer as feedback information on bad buyer for tracking community input on historical transaction experiences to the server computer.

The recording media may further include: editing and storing information on properties, so as to display the text that the user desires, when the user moves a cursor over the virtual real estate by connecting the server computer through the user terminal, if the administration for virtual real estate is desired.

The recording media may further include: outputting a user-specified web page or a blog, when a region on the digital map, on which the virtual real estate is located, is clicked.

The recording media may further include: providing a virtual item through the server computer, so as to enable the virtual item to be purchased through the user terminal, for the purpose of enhancing a value of virtual real estate and decorating the real estate for further personalization and enjoyment.

The recording media may further include: registering the virtual real estate as real estate for sale in a region where the virtual real estate is located, if the owner of the virtual real estate desires to sell the virtual real estate.

### BRIEF DESCRIPTION OF THE DRAWINGS

The accompanying appendices and/or drawings illustrate various non-limiting, example, inventive aspects in accordance with the present disclosure:

FIG. 1 is a diagram showing the configuration of a system for providing commercial transaction services for a virtual real estate according to one embodiment of the present invention.

FIG. 2 is a flow chart illustrating preparatory procedures for providing commercial transaction services for a virtual real estate using a digital map according to one embodiment of the present invention.

FIG. 3 is a diagram showing a general digital map.

FIG. 4 is a diagram showing a digital map from which general point of interest (POI) information, except public information, is removed according to one embodiment of the present invention.

FIG. 5 is a flow chart illustrating a procedure for performing the sale and administration of virtual real estate according to one embodiment of the present invention.

FIG. 6 is a diagram showing a digital map divided in the shape of a grid.

FIG. 7 is a diagram showing a digital map on which an area is selected using a drawing tool.

FIG. 8 is a diagram showing a digital map on which the text that is desired by an owner of a virtual real estate is displayed.

FIG. 9 is a diagram showing a digital map on which virtual real estate for sale is registered and displayed by the owner who wants to sell the virtual real estate.

FIG. 10 is a diagram showing an automatic connection page and personalization of the owner's virtual real estate.

FIG. 11 is of a block diagram illustrating embodiments of the present invention of an Electronic Real Estate Transaction system controller.

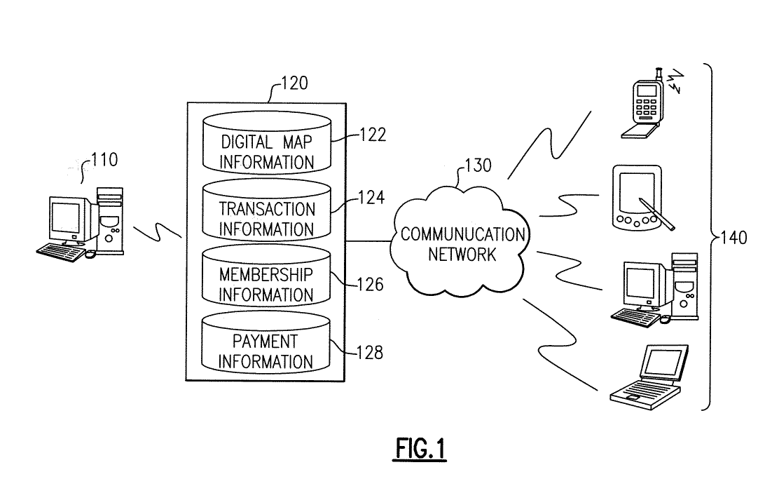

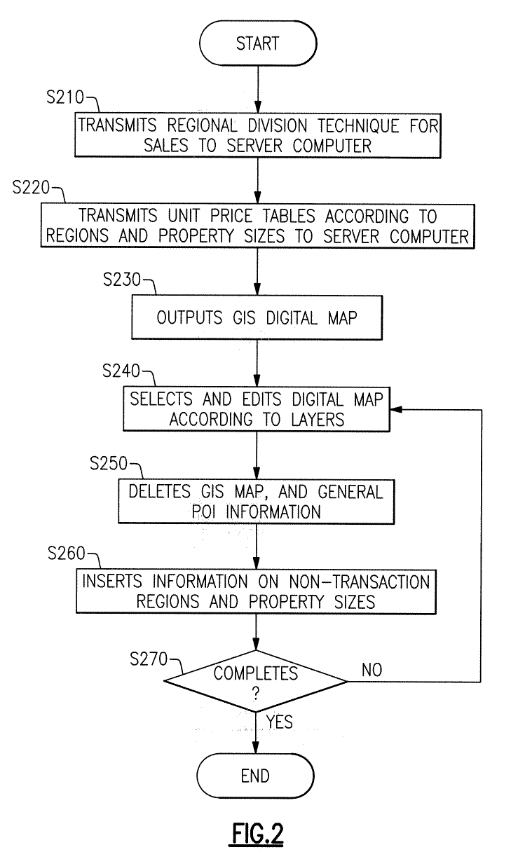

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION ELECTRONIC REAL ESTATE TRANSACTIONS

Advantages and features present in this disclosure and methods of accomplishing the same may be understood more readily by reference to the following detailed description and the accompanying drawings.

FIG. 1 is a diagram illustrating the configuration of a system for providing commercial transaction services of virtual real estate according to one embodiment of the present invention.

A system for providing commercial transaction services of virtual real estate includes an operator computer 110, a server computer 120 and a user terminal that is connected with the server computer 120 through a communication network 130. The operator computer 110 performs creation and editing of a digital map, and modification of related programs. The server computer 120 is charged with controlling the management of data on rendered digital maps, the sales of virtual real estate, the auction of virtual real estate and the like. The user terminal 140 performs inspection, sales and administration of virtual real estate on a site that is operated by the server computer 120, and performs communication with the server computer 120 through the communication network 130.

The operator computer 110 may be a personal computer such as a desktop computer including a central processing unit (CPU), a random access memory (RAM), a data storage device and the like, and a laptop computer, a workstation or a mass storage computer.

The server computer 120 may be a mass storage computer system including a CPU, a RAM, a data storage device and the like. Further, the server computer 120 may be a personal computer having a memory for mass storage data and data processing capability or a workstation.

The server computer 120 is equipped with a database 122 for digital map information on sales of virtual real estate, a database 124 for transaction information on sales and auction, a database 126 for information on members and a database 128 for payment information necessary for transactions of virtual real estate, where programs for general online transactions and information management are stored. The server computer 120 controls general operations necessary for commercial transactions of virtual real estate, and writes new data in the database or deletes data. Information such as property size information on non-transaction regions, price table information and price estimation information is stored in the database 122 for digital map information. The transaction information includes information such as a location, address, owner and property size of virtual real estate. The virtual real estate, which is displayed in the form of a digital map, is displayed on the user terminal 140 through the server computer 120.

The communication network 130 may be composed of an internet network, a wireless communication network, or their combination, and include all means for performing communication between the server computer 120 and the user terminal 140.

The user terminal 140 may be a desktop computer for performing communication with the server computer 120, a laptop computer, a personal digital assistant (PDA) terminal, a cellular phone, a wireless phone and the like, and include all wire and wireless devices for connecting with the communication network 130 in wire and wireless. The user terminal 140 has a web browser or specific software for displaying contents of a web page in the form of a hypertext markup language (HTML), Flash or other associated web language. The web browser or the software enables the user terminal 140 to access and display contents such as a digital map for virtual real estate provided from the server computer 120 and a web-encoded (with HTML) template for sales. The web browser may be internet Explorer, Firefox, Netscape and the like. The web-encoded (with HTML) template provided from the server computer 120 has a main web page to be displayed to the user terminal 140.

FIG. 2 is a flow chart illustrating a preparatory process for performing a commercial transaction of virtual real estate using a digital map according to one embodiment of the present invention.

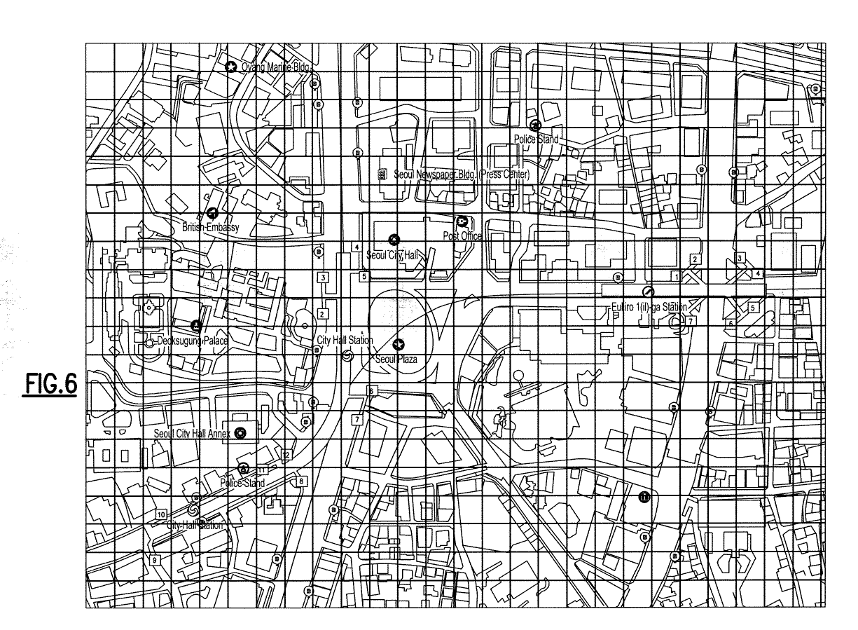

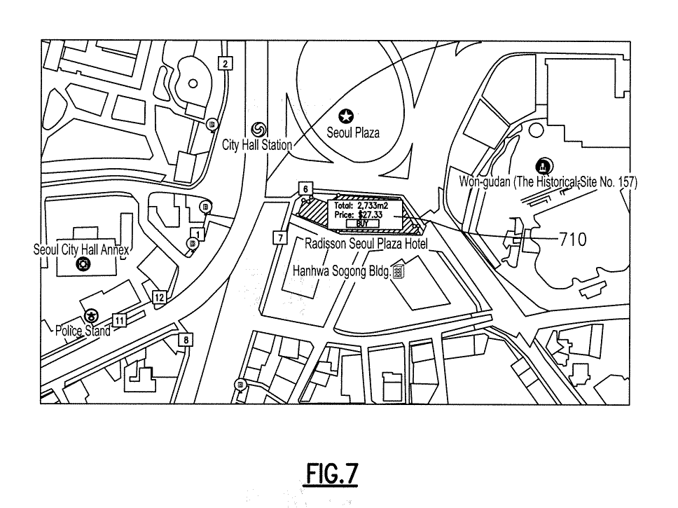

The operator computer 110 transmits a program, in which regional division information is coded on the digital map for selling of regions of the virtual real estate, to the server computer 120, and the server computer 120 stores the transmitted program S210. The regional division technique on the digital map may be a technique that is divided in the form of grid as shown in FIG. 6 and a technique in which a region is set in a polygonal form by connecting points clicked through the user terminal 140 with a drawing tool provided from the server computer 120 on the digital map as shown in FIG. 7.

Further, the operator computer 110 codes and transmits sales unit price tables (price tables) according to regions and property sizes to the server computer 120, and the server computer 120 stores information on the coded and transmitted sales unit price tables S220. Additionally, information on a price estimation technique according to property size of the digital map and property size of non-transaction regions is stored.

The operator computer 110 outputs a geographic information system (GIS) digital map S230, and selects the digital map according to layers representing the degree of magnification (or scale) S240.

The operator computer 110 deletes general POI information, except public information such as subway lines, road names, parks, government and public offices and the like S250, and inserts information on non-transaction regions such as roads, mountains, rivers and governmental agencies into digital map data S260. The digital map is completely created by executing the above process repeatedly according to respective layers S270. The completed digital map data are transmitted to the server computer 120, and the server computer 120 stores the digital map data in the database 122 for digital map information.

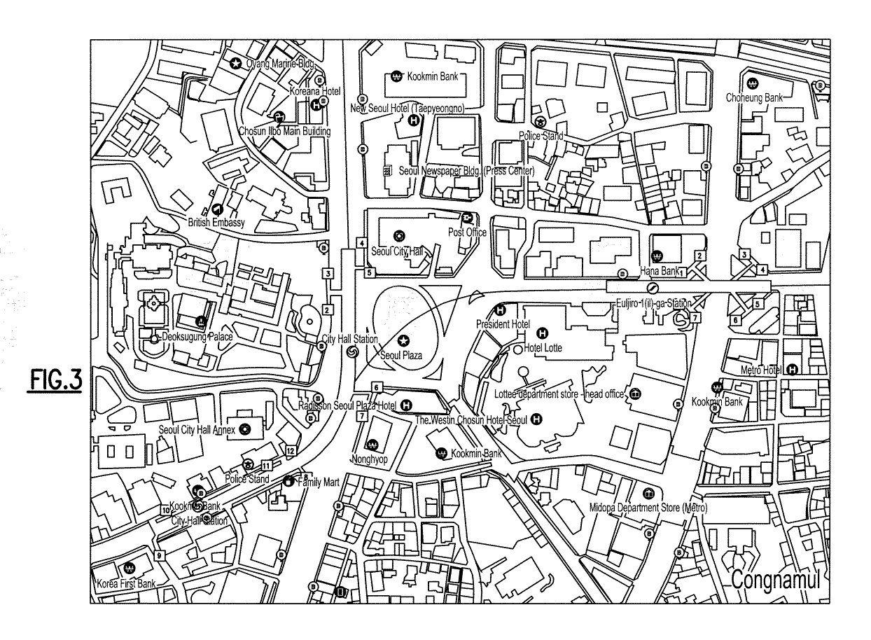

FIG. 3 is a diagram illustrating a general digital map.

Referring to FIG. 3, a digital map is embodied through digital conversion, by collecting and processing ground information in relation to mountains, rivers, lakes, parks, governmental agencies, roads and the like. A general digital map includes information on roads and regions and POI information combined. The POI represents data displayed on the digital map, by means of making coordinates, airports, stations, terminals, hotels, schools, government and public offices, properties and the like.

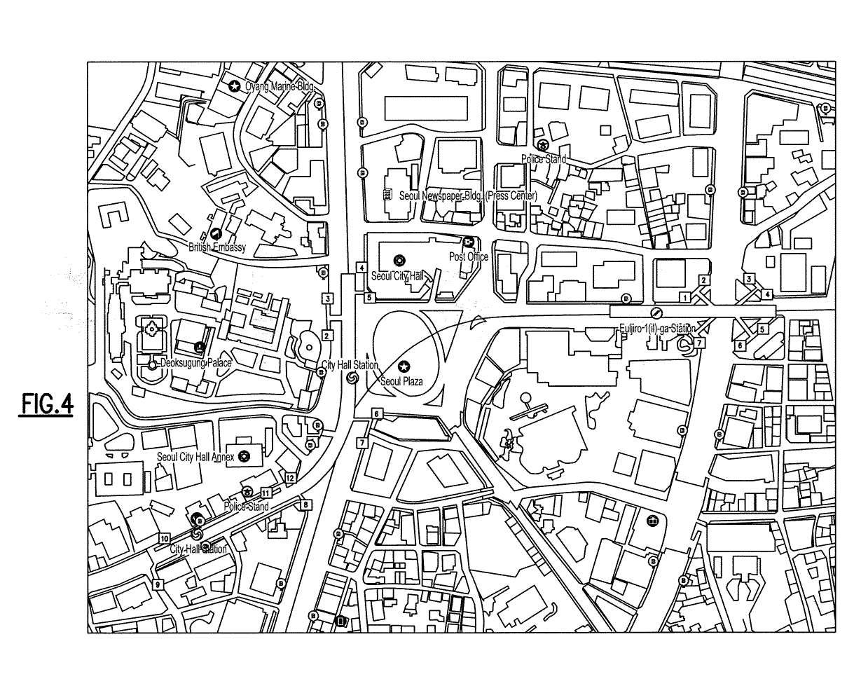

FIG. 4 is a diagram illustrating a digital map from which general POI information is deleted, except public information, according to a desirable exemplary embodiment of the present invention.

Referring to FIG. 4, it can be understood that POI information other than public information such as subway lines, road names, government and public offices, is deleted from digital map information, and information on non-transaction regions are inserted into the digital map data. The digital map is generated by a geographic information system (GIS), with POI information. However, POI information except specific topographical features such as mountains, rivers, lakes and the like and main public facilities such as parks and governmental agencies is deleted.

The digital map may be generated by scanning a paper map on the basis of surveying and converting into digital images, or by making use of a GPS receiver or a satellite. To clarify, as an example, the real paper map can be passed through a scanning process and the scanned data converted into digital images. The converted images are projected to a coordinates system by passing through an image editing process that can remove noises and modify. In the process for executing modification, general POI information is deleted, except specific topographical features and public facilities. The images projected to the coordinates system are divided according to layers, on a reduced scale.

Likewise, the digital map displayed on the user terminal 140 includes layers that are displayed in a fixed property size through scaling. The digital map made through scaling is divided and stored according the layers. Accordingly, as the digital map on a small scale includes data on digital maps on a large scale joined together, it enables digital maps that are shown through movement between layers to mutually correspond to each other. For example, after determination of coordinates, and centering on the determined coordinates, the location is displayed to user terminal 140, even though a small-scale layer is changed into a large-scale layer, or, conversely, a large-scale into a small-scale layer.

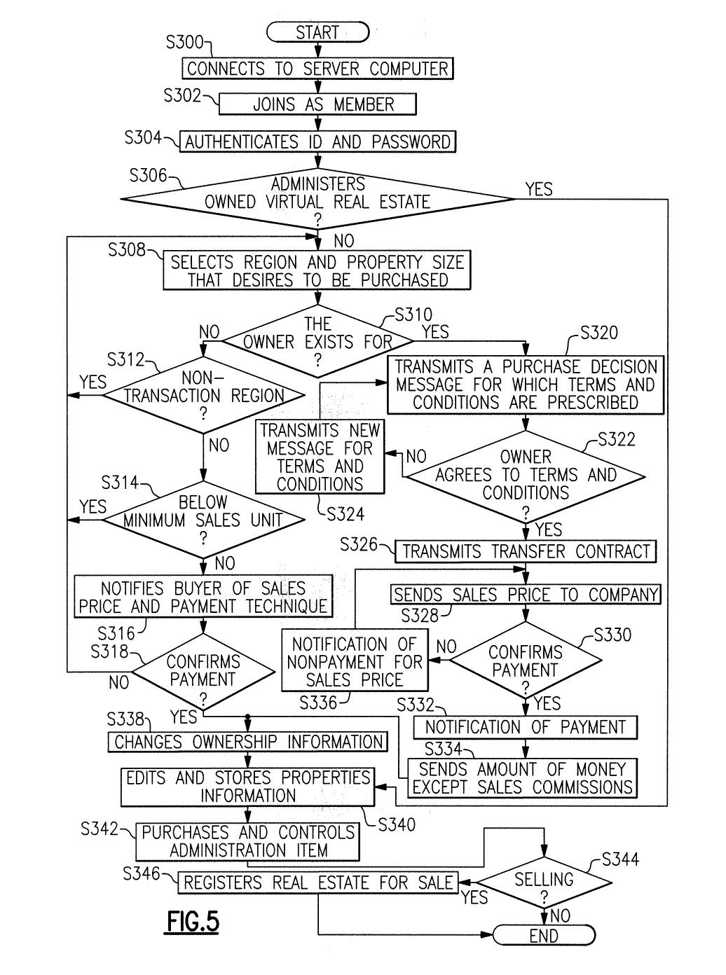

FIG. 5 is a flow chart illustrating a process for performing sales or administration of virtual real estate according to one embodiment of the present invention. A program capable of being executed in a computer for performing sales or administration of virtual real estimate may be recorded in a computer-readable recording media.

If joining as a member, the user terminal 140 connects to the server computer 120 through the communication network 130 S300, and the user joins as a member S302. The server computer 120 records member information in a member information database 126, when predetermined member information is inputted through the user terminal 140 and transmits a message for notifying the user that the joining process is successfully performed to the user terminal 140. The member information may be an ID, a password, a user name, a residence registration number, a telephone number, an address, an e-mail address, a sex distinction, and others. The ID and password may be used as member authentication information, while the user name, residence registration number, telephone number, address, e-mail address and sex distinction may be used as personal information. The server computer 120 stores and controls information on the recently joined members in the member information database 126.

After completion of joining, member authentication information including an ID and a password is inputted through the user terminal 140, and the inputted information is authenticated through the server computer 120 S304. The server 120 refers to the inputted member authentication information form the member information database and judges whether a member or not, according to a judgment result, it permits or refuses to perform login. In a case where the user is not a member who is registered in the member information database, it refuses to log in and requests that the user join as a member.

After authentication, the user connects to a site provided by the server computer 120 through the user terminal 140 and performs a commercial transaction of virtual real estate and administers owned virtual real estate according to the user's selection S306.

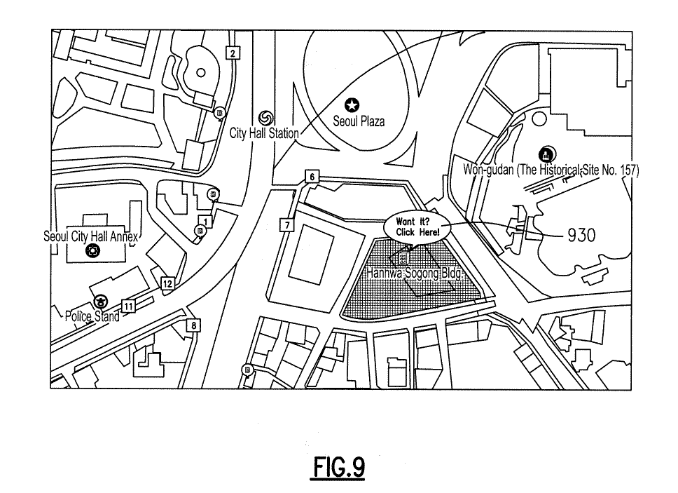

If the user desires to purchase virtual real estate, the user selects a desired region and property size through the user terminal 140 on the digital map S308. A selection technique may be a technique for enabling a user to select a region by the piece on the digital map divided into the form of a grid as shown in FIG. 6, and a technique for enabling a user to set and select a region in a polygonal form by connecting points that are clicked through the user terminal 140 with a drawing tool provided from the server computer 120 on the digital map, as shown in FIG. 7. Further, as shown in FIG. 9, the user may select real estate for sale directly, that is notified on the digital map. The method for selecting a region and property size is set by the operator computer 110, and being transmitted and stored in the server computer 120.

After selection of a region, the server computer 120 checks whether the owner exists for the selected region S310. If the owner does not exist, the server computer 120 checks whether the selected region is a non-transaction region S312. If it is not a non-transaction region, the server computer 120 checks whether to select the minimum unit region S314.

In a case where it is a non-transaction region or below the minimum sales size, the user reselects a region and a property size S308.

In a case where it is not a non-transaction region and above the minimum sales unit, the property size and sales price 710 of the selected region, as shown in FIG. 7, is displayed on the user terminal 140 by means of the server computer 120.

If the purchase of the virtual real estate, corresponding to the selected region, is selected through the user terminal 140, the server computer 120 transmits a sales price and a payment technique to the user terminal 140 S316. If it is verified that the purchasing price of the virtual real estate has paid S318, the server computer 120 changes and stores ownership information on the virtual real estate S338, and transmits to the buyer's terminal 140 a message for notifying the user that ownership of the virtual real estate is achieved. If a purchasing price of the virtual real estate is not paid, the user reselects a region and a property size S308.

The purchasing price of the virtual real estate may be paid through various payment means selected by the user. The payment means may include cash payment, credit card payment, transfer payment, reserve payment, gift certificate payment, discount coupon payment and the like. Further, the transaction may be paid through multiple payment resources, for example, payment combining credit card payment and gift certificate payment.

If the owner exists for the region and property size selected by the user, the buyer who desires to purchase the property transmits a purchase decision message for which terms and conditions provided from the server computer 120 are displayed to the owner's terminal 140 as another user S320. The owner judges whether to agree to the terms and conditions, corresponding to the purchase decision message S322.

If the owner does not agree to the terms and conditions sent from the buyer, the owner transmits a new message for terms and conditions to the buyer's terminal 140 through the server computer 120 S324.

If the owner agrees to the terms and conditions sent from the buyer, the transfer agreement provided from the server computer 120 through the owner's terminal 140 is transmitted to the buyer's terminal 140 and the server computer 120 S326.

The buyer sends the amount of sales price to an account desired by the operator S328.

If it is verified that the sales price prescribed in the transfer agreement is paid S330, the operator computer 110 notifies the owner's terminal 140 and the buyer's terminal 140 of the payment, respectively S332, and the operator computer 110 sends the amount of money, except fixed commissions, to an account or with a payment technique that the owner desires S334. The server computer 120 changes ownership information on the virtual real estate S338, and notifies the buyer's terminal 140 of changed contents of the ownership information.

If it is not verified that the buyer sends the money, even after the regular time has elapsed since the transfer agreement is received from the owner S330, the operator notifies the owner's terminal 140 and the buyer that the money has not been paid, respectively S336. The buyer who has received the notification of nonpayment sends the money S328, and if the payment is verified S330, the operator computer 110 notifies the owner's terminal 140 and the buyer's terminal 140 of the payment S332, and sends the amount of money, except fixed commissions, to an account of the owner S334. The server computer changes ownership information of the virtual real estate S338 and notifies the buyer of changed information of the ownership information.

In case of nonpayment, the owner stops the transaction according to the owner's desire, and transmits information on the buyer as feedback information on bad buyer for tracking community input on historical transaction experience to the server computer 120.

If the user wants to administer properties (the virtual real estate), the user may edit and store information on the properties by connecting the server computer 120 through the user terminal 140 S340. Likewise, administration of the properties may enhance the value of real estate of the owner and administer the real estate by purchasing additional items in a virtual space for further personalization and enjoyment.

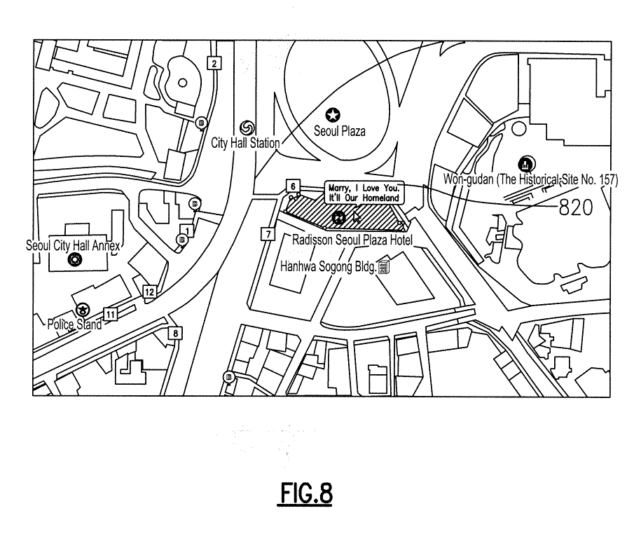

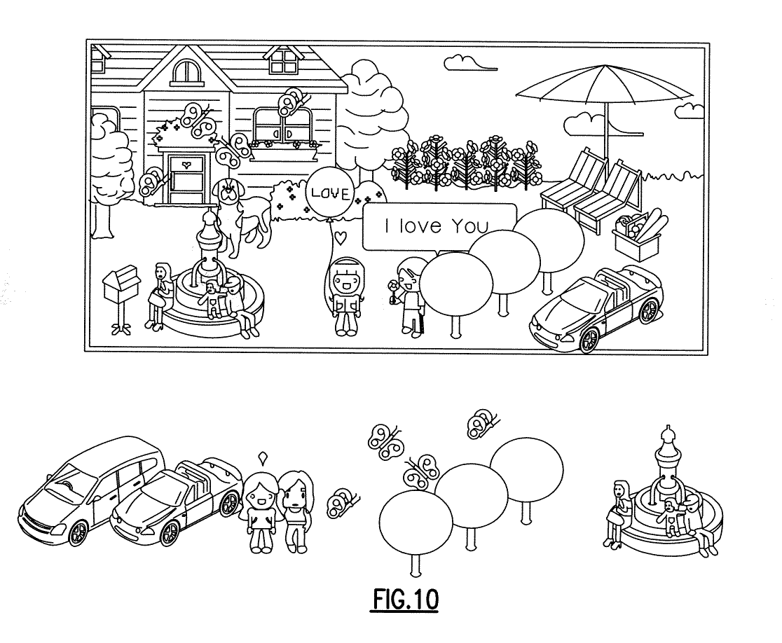

As shown in FIG. 8, if the user moves a cursor over the virtual real estate purchased by the user, a text 820 desired by the user is displayed, and if the text 820 is again clicked, as shown in FIG. 10, a user specified web page or a blog, which is provided from the server computer 120, may be outputted S340.

The owner of the virtual real estate may buy a virtual item such as a house, a building, a car, a garden and so on, so as to enhance the value of the bought real estate and decorate the real estate for fun S342. For this, the operator computer 110 makes the house, the building, the car, the garden and so on which the user desires to decorate in the real estate and provides them to the server computer 120, thereby allowing the user to purchase virtual items in the virtual space.

If the owner or the operator wants to sell the virtual real estate that is owned by the owner or the operator S344, as shown in FIG. 9, the real estate for sale may be registered on the digital map S346.

Further, the user registers the real estate on a notice board of a site provided from the server computer 120 and inputs information on sales, the real estate may be sold to the buyer. Information on real estate for sale may include a location, a property size, sales price and so on of the real estate. The inputted information on real estate for sale is registered on the notice board through the server computer 120 and displayed in a web page. The buyer may purchase the virtual real estate by searching the registered information.

The owner who owns the virtual real estate inputs information on the real estate which is for sale to virtual spaces (the owner's homepage, blog and so on) including the server computer 120 through the communication network 130, and if another user who searches the information on real estate for sale desires to purchase the property, the virtual real estate may be sold. For this, information on real estate for sale is inputted to the virtual online space by means of the user terminal 140, and the real estate for sale is selected by the user terminal 140, thereby performing the transaction for the virtual real estate.

Further, if the transaction for the virtual real estate is performed and transfer request for the virtual real estate is received from the owner's terminal 140 or the buyer's terminal 140, the server computer 120 pays in fixed commissions and updates the database for information on the virtual real estate so as to enable the ownership information to be changed.

As described above, the present invention may restrict the sales of specific topographical features such as mountains, rivers, lakes and so on, and main public facilities such as parks, governmental agencies and so on, on a digital map that is composed of a real geographic information system (GIS) on the internet, reform the digital map with data from which general POI information except them is deleted, enable a general user to directly purchase real estate in a desired region, property size and shape with online system, and sell the real estate to the buyer who desires to purchase the real estate through a general sales or an auction.

Regardless of whether or not the real estate is owned and rented out, the present invention enables the user to own real estate or provide the commercial transaction service of rentable virtual real estate on the digital map like the real thing in a virtual world such as the internet, thereby providing proxy satisfaction for owning real estate to the user and bringing about an economic activity through the commercial transaction of virtual real estate.

Further, since the user may connect to his own website or blog through the text, graphic, or link, a new effect of publicity, marketing and social interaction for a person or a company can be expected.

It should be understood by those of ordinary skill in the art that various replacement, modifications and changes in the form and details may be made therein without departing from the intention and scope of the present invention as defined by the following claims. Therefore, it is to be appreciated that the above described embodiments are for illustration only and are not to be construed as limitations of the invention.

### Electronic Real Estate Transaction Controller

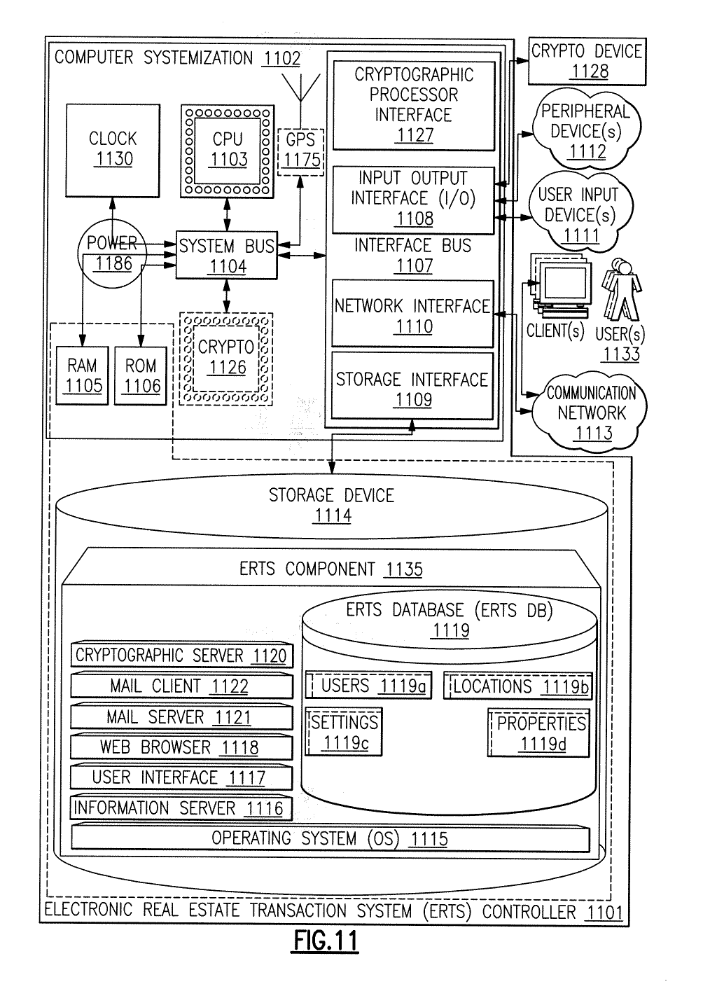

FIG. 11 of the present disclosure illustrates inventive aspects of a Electronic Real Estate Transaction controller 1101 in a block diagram. In this embodiment, the Electronic Real Estate Transaction controller 1101 may serve to aggregate, process, store, search, serve, identify, instruct, generate, match, and/or facilitate interactions with a real estate through electronic transactions, and/or other related data.

Typically, users, which may be people and/or other systems, engage information technology systems (e.g., commonly computers) to facilitate information processing. In turn, computers employ processors to process information; such processors are often referred to as central processing units (CPU). A common form of processor is referred to as a microprocessor. CPUs use communicative signals to enable various operations. Such communicative signals may be stored and/or transmitted in batches as program and/or data components facilitate desired operations. These stored instruction code signals may engage the CPU circuit components to perform desired operations. A common type of program is a computer operating system, which, commonly, is executed by CPU on a computer; the operating system enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through a database program. Information technology systems provide interfaces that allow users to access and operate various system components.

In one embodiment, the Electronic Real Estate Transaction system controller 1101 may be connected to and/or communicate with entities such as, but not limited to: one or more users from user input devices 1111; peripheral devices 1112; a cryptographic processor device 1128; and/or a communications network 1113.

Networks are commonly thought to comprise the interconnection and interoperation of clients, servers, and intermediary nodes in a graph topology. It should be noted that the term “server” as used throughout this disclosure refers generally to a computer, other device, program, or combination thereof that processes and responds to the requests of remote users across a communications network. Servers serve their information to requesting “clients.” The term “client” as used herein refers generally to a computer, other device, program, or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the internet is generally accepted as being an interconnection of a multitude of networks whereby remote clients and servers may access and interoperate with one another.

The Electronic Real Estate Transaction system controller 1101 may be based on common computer systems that may comprise, but are not limited to, components such as: a computer systemization 1102 connected to memory 1129.

Computer Systemization

A computer systemization 1102 may comprise a clock 1130, central processing unit (CPU) 1103, a read only memory (ROM) 1106, a random access memory (RAM) 1105, and/or an interface bus 1107, and most frequently, although not necessarily, are all interconnected and/or communicating through a system bus 1104. Optionally, the computer systemization may be connected to an internal power source 1186. Optionally, a cryptographic processor 1126 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s). The CPU interacts with memory through signal passing through conductive conduits to execute stored signal program code according to conventional data processing techniques. Such signal passing facilitates communication within the Electronic Real Estate Transaction system controller and beyond through various interfaces. Should processing requirements dictate a greater amount speed, parallel, mainframe and/or super-computer architectures may similarly be employed. Alternatively, should deployment requirements dictate greater portability, smaller Personal Digital Assistants (PDAs) may be employed.

Power Source

The power source 1186 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1186 is connected to at least one of the interconnected subsequent components of the Electronic Real Estate Transaction system thereby providing an electric current to all subsequent components. In one example, the power source 1186 is connected to the system bus component 1104. In an alternative embodiment, an outside power source 1186 is provided through a connection across the I/O 1108 interface. For example, a USB and/or IEEE 1394 connection carries both data and power across the connection and is therefore a suitable source of power.

Interface Adapters

Interface bus(ses) 1107 may accept, connect, and/or communicate to a number of interface adapters, conventionally although not necessarily in the form of adapter cards, such as but not limited to: input output interfaces (I/O) 1108, storage interfaces 1109, network interfaces 1110, and/or the like. Optionally, cryptographic processor interfaces 1127 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1109 may accept, communicate, and/or connect to a number of storage devices such as, but not limited to: storage devices 1114, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1110 may accept, communicate, and/or connect to a communications network 1113. Through a communications network 1113, the Electronic Real Estate Transaction system controller is accessible through remote clients 1133b (e.g., computers with web browsers) by users 1133a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the internet; a Local Area Network (LAN); a Metropolitan Area Network (MAN); an Operating Missions as Nodes on the internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1110 may be used to engage with various communications network types 1113. For example, multiple network interfaces may be employed to allow for the communication over broadcast, multicast, and/or unicast networks.

Input Output interfaces (I/O) 1108 may accept, communicate, and/or connect to user input devices 1111, peripheral devices 1112, cryptographic processor devices 1128, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set 145, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 1111 may be card readers, dongles, finger print readers, gloves, graphics tablets, joysticks, keyboards, mouse (mice), remote controls, retina readers, trackballs, trackpads, and/or the like.

Peripheral devices 1112 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the Electronic Real Estate Transaction system controller may be embodied as an embedded, dedicated, and/or monitor-less (i.e., headless) device, wherein access would be provided over a network interface connection.

Cryptographic units such as, but not limited to, microcontrollers, processors 1126, interfaces 1127, and/or devices 1128 may be attached, and/or communicate with the Electronic Real Estate Transaction system controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 40 MHz Roadrunner 184.

Memory

Generally, any mechanization and/or embodiment allowing a processor to affect the storage and/or retrieval of information is regarded as memory 1129. However, memory is a fungible technology and resource, thus, any number of memory embodiments may be employed in lieu of or in concert with one another. It is to be understood that the Electronic Real Estate Transaction system controller and/or a computer systemization may employ various forms of memory 1129. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 1129 will include ROM 1106, RAM 1105, and a storage device 1114. A storage device 1114 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); an array of devices (e.g., Redundant Array of Independent Disks (RAID)); and/or other devices of the like. Thus, a computer systemization generally requires and makes use of memory.

Component Collection

The memory 1129 may contain a collection of program and/or database components and/or data such as, but not limited to: operating system component(s) 1115 (operating system); information server component(s) 1116 (information server); user interface component(s) 1117 (user interface); Web browser component(s) 1118 (Web browser); database(s) 1119; mail server component(s) 1121; mail client component(s) 1122; cryptographic server component(s) 1120 (cryptographic server); the Electronic Real Estate Transaction system component(s) 1135; and/or the like (i.e., collectively a component collection). These components may be stored and accessed from the storage devices and/or from storage devices accessible through an interface bus. Although non-conventional program components such as those in the component collection, typically, are stored in a local storage device 1114, they may also be loaded and/or stored in memory such as: peripheral devices, RAM, remote storage facilities through a communications network, ROM, various forms of memory, and/or the like.

Operating System

The operating system component 1115 is an executable program component facilitating the operation of the Electronic Real Estate Transaction system controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the Electronic Real Estate Transaction system controller to communicate with other entities through a communications network 1113. Various communication protocols may be used by the Electronic Real Estate Transaction system controller as a subcarrier transport mechanism for interaction, such as, but not limited to: multicast, TCP/IP, UDP, unicast, and/or the like.

Information Server

An information server component 1116 is a stored program component that is executed by a CPU. The information server may be a conventional internet information server such as, but not limited to Apache Software Foundation's Apache, Microsoft's internet Information Server, and/or the. The information server may allow for the execution of program components through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the Electronic Real Estate Transaction system controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the Electronic Real Estate Transaction system database 1119, operating systems, other program components, user interfaces, Web browsers, and/or the like.

Access to the Electronic Real Estate Transaction system database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the Electronic Real Estate Transaction system. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the Electronic Real Estate Transaction system as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, Microsoft's Windows XP, or Unix's X-Windows provide a baseline and means of accessing and displaying information graphically to users.

A user interface component 1117 is a stored program component that is executed by a CPU. The user interface may be a conventional graphic user interface as provided by, with, and/or atop operating systems and/or operating environments such as Apple Macintosh OS, e.g., Aqua, GNUSTEP, Microsoft Windows (NT/XP), Unix X Windows (KDE, Gnome, and/or the like), mythTV, and/or the like. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component 1118 is a stored program component that is executed by a CPU. The Web browser may be a conventional hypertext viewing application such as Microsoft internet Explorer or Netscape Navigator. Secure Web browsing may be supplied with 128 bit (or greater) encryption by way of HTTPS, SSL, and/or the like. Some Web browsers allow for the execution of program components through facilities such as Java, JavaScript, ActiveX, and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the Electronic Real Estate Transaction system enabled nodes. The combined application may be nugatory on systems employing standard Web browsers.

Mail Server

A mail server component 1121 is a stored program component that is executed by a CPU 1103. The mail server may be a conventional internet mail server such as, but not limited to sendmail, Microsoft Exchange, and/or the. The mail server may allow for the execution of program components through facilities such as ASP, ActiveX, (ANSI) (Objective-) C (++), CGI scripts, Java, JavaScript, PERL, pipes, Python, WebObjects, and/or the like. The mail server may support communications protocols such as, but not limited to: internet message access protocol (IMAP), Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the Electronic Real Estate Transaction system.

Access to the Electronic Real Estate Transaction system mail may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component 1122 is a stored program component that is executed by a CPU 1103. The mail client may be a conventional mail viewing application such as Apple Mail, Microsoft Entourage, Microsoft Outlook, Microsoft Outlook Express, Mozilla Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component 1120 is a stored program component that is executed by a CPU 1103, cryptographic processor 1126, cryptographic processor interface 1127, cryptographic processor device 1128, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the Electronic Real Estate Transaction system may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the Electronic Real Estate Transaction system component to engage in secure transactions if so desired. The cryptographic component facilitates the secure accessing of resources on the Electronic Real Estate Transaction system and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The Electronic Real Estate Transaction system Database

The Electronic Real Estate Transaction system database component 1119 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the Electronic Real Estate Transaction system database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the Electronic Real Estate Transaction system database is implemented as a data-structure, the use of the Electronic Real Estate Transaction system database 1119 may be integrated into another component such as the Electronic Real Estate Transaction system component 1135. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1119 includes several tables 1119a-e. A users table 1119a includes fields such as, but not limited to: a user name, email address, address, profile, user_id, and/or the like. An locations table 1119b includes fields such as, but not limited to: location_id, geocode_id, longitude, latitude, boundaries, and/or the like. A settings table 1119c includes fields such as, but not limited to: settings_id, preferences, and/or the like. A properties table 1119d includes fields such as, but not limited to: location_id, longitude, latitude, boundaries, lot_id, address, city, zip, country, and/or the like.

In one embodiment, the Electronic Real Estate Transaction system database may interact with other database systems. For example, employing a distributed database system, queries and data access by Electronic Real Estate Transaction system component may treat the combination of the Electronic Real Estate Transaction system database, an integrated data security layer database as a single database entity.

In one embodiment, user programs may contain various user interface primitives, which may serve to update the Electronic Real Estate Transaction system. Also, various accounts may require custom database tables depending upon the environments and the types of clients the Electronic Real Estate Transaction system may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1119a-e. The Electronic Real Estate Transaction system may be configured to keep track of various settings, inputs, and parameters via database controllers.

The Electronic Real Estate Transaction system database may communicate to and/or with other components in a component collection, including itself, and/or facilities of the like. Most frequently, the Electronic Real Estate Transaction system database communicates with the Electronic Real Estate Transaction system component, other program components, and/or the like. The database may contain, retain, and provide information regarding other nodes and data.

The Electronic Real Estate Transaction system

The Electronic Real Estate Transaction system component 1135 is a stored program component that is executed by a CPU. The Electronic Real Estate Transaction system affects accessing, obtaining and the provision of information, services, transactions, and/or the like across various communications networks.

The Electronic Real Estate Transaction system component enables and provides a straightforward, unified, and efficient system to engage in the transaction of real estate.

The Electronic Real Estate Transaction system component enabling access of information between nodes may be developed by employing standard development tools such as, but not limited to: (ANSI) (Objective-) C (++), Apache components, binary executables, database adapters, Java, JavaScript, mapping tools, procedural and object oriented development tools, PERL, Python, shell scripts, SQL commands, web application server extensions, WebObjects, and/or the like. In one embodiment, the Electronic Real Estate Transaction system server employs a cryptographic server to encrypt and decrypt communications. The Electronic Real Estate Transaction system component may communicate to and/or with other components in a component collection, including itself, and/or facilities of the like. Most frequently, the Electronic Real Estate Transaction system component communicates with the Electronic Real Estate Transaction system database, operating systems, other program components, and/or the like. The Electronic Real Estate Transaction system may contain, communicate, generate, obtain, and/or provide program component, system, user, and/or data communications, requests, and/or responses.

Distributed Electronic Real Estate Transaction system

The structure and/or operation of any of the Electronic Real Estate Transaction system node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the Electronic Real Estate Transaction system controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. Again, the configuration will depend upon the context of system deployment.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

What is claimed is:

1. A method for providing commercial transaction services of virtual real estate by connecting at least one operator computer, a server computer for controlling a digital map and a communication transaction, and at least one user terminal, through a communication network, comprising:
storing a program, in which a regional division technique is coded on a digital map for sales of virtual real estate, in the server computer;
storing information on which sales price tables according to regions and property sizes of virtual real states are coded, information on a technique for estimating a price according to a property size and information on non-transaction regions, in the server computer;
outputting a geographic information system (GIS) digital map and selecting the digital map according to layers representing the area in reduced scale;
deleting general point of interest (POI) information, except public information, from information displayed on the layer and inserting information on non-transaction regions including specific topographical features and public facilities into digital map data;
creating a digital map and storing the created digital map in the server computer by repeatedly executing the process for deleting the general POI information according to respective layers and inserting the information on non-transaction regions into the digital map data; and
performing a transaction or administration of virtual real estate to be performed, on the basis of the digital map, by means of the server computer, through the user terminal.

2. The method of claim 1, wherein the performing a transaction or administration of the virtual real estate, includes:
(a) selecting a desired region and a property size on the digital map through the user terminal;
(b) enabling the server computer to determine whether an owner exists for the selected region;
(c) displaying the property size and sales price of the selected region on the user terminal, if the owner does not exist, transmitting the sales price and payment technique to the user terminal, if a purchase of the virtual real estate, corresponding to the selected region, is selected through the user terminal, and enabling the server computer to change and store ownership information of the virtual real estate, if it is verified that the purchasing price of the virtual real estate is paid; and
(d) transmitting a purchase decision message, for which terms and conditions are prescribed, to the owner's terminal, if the owner exists for the selected region, and enabling the server computer to change and store the ownership information of the virtual real estate, if the owner agrees to the terms and conditions sent from a buyer who desires to purchase the property and it is verified that a sales price prescribed in a transfer agreement is paid.

3. The method of claim 2, wherein the (c) includes:
determining whether the selected region is a non-transaction region and a minimum sales unit region, if the owner does not exist;
selecting a region and a property size again, if the selected region is a non-transaction region or below the minimum sales unit;
displaying the property size and the sales price of the selected region on the user terminal, if the selected region is not a non-transaction region and above the minimum sales unit, and transmitting the sales price and the payment technique to the user terminal, if the purchase of the virtual real estate, corresponding to the selected region, is selected through the user terminal; and
enabling the server computer to change and store the ownership information of the virtual real estate, if it is verified that the purchasing price of the virtual real estate is paid.

4. The method of claim 3, further comprising: selecting a region and a property size again, if the payment for buying the virtual real estate is not performed.

5. The method of claim 2, wherein the (d) comprises:
transmitting a purchase decision message, for which terms and conditions are prescribed, to the owner's terminal, if the owner exists for the selected region;
transmitting a new message for terms and conditions to a terminal of a buyer who desires to purchase the property, if the owner does not agree to the terms and conditions;
transmitting a transfer agreement to the buyer's terminal and the server computer, if the owner agrees to the terms and conditions; and
if it is verified that the sales amount of money prescribed in the transfer agreement is paid, notifying the owner's terminal and the buyer's terminal of the payment, respectively, enabling an amount of money, except pre-specified sales commissions, to be sent to an account or with a payment technique that the owner desires, enabling the server computer to change and store ownership information of the virtual real estate, and notifying the buyer of changed contents of the ownership information.

6. The method of claim 5, further comprising:
notifying the owner's terminal and the buyer's terminal of the nonpayment, if it is not verified that the buyer sends the amount of money, even after the regular time has be passed since the transfer agreement is received from the owner; and
stopping the transaction, according to the owner's desire, if there is nonpayment, and transmitting information on the buyer as feedback information on bad buyer for tracking community input on historical transaction experiences to the server computer.

7. The method of claim 2, further comprising: editing and storing information on properties, so as to display the text that the user desires, when the user moves a cursor over the virtual real estate by connecting the server computer through the user terminal, if the administration for virtual real estate is desired.

8. The method of claim 2, further comprising: outputting a user-specified web page or a blog, when a region on the digital map, on which the virtual real estate is located, is clicked.

9. The method of claim 2, further comprising: providing a virtual item through the server computer, so as to enable the virtual item to be purchased through the user terminal, for the purpose of enhancing a value of virtual real estate and decorating the real estate for further personalization and enjoyment.

10. The method of claim 2, further comprising: registering the virtual real estate as real estate for sale in a region where the virtual real estate is located, if the owner of the virtual real estate desires to sell the virtual real estate.

11. In a method for providing commercial transaction services of virtual real estate by connecting at least one operator computer, a server computer for controlling a digital map and a communication transaction, and at least one user terminal, through a communication network, a computer-readable recording media in which a program being executed in a computer is stored, comprising:
(a) providing to the server computer a digital map on which general POI information, except public information, is deleted, and information on non-transaction regions including specific topographical features and public facilities is inserted;
(b) selecting a desired region and a property size on the digital map through the user terminal;
(c) enabling the server computer to determine whether an owner exists for the selected region;
(d) displaying the property size and sales price of the selected region on the user terminal, if the owner does not exist, transmitting the sales price and payment technique to the user terminal, if a purchase of the virtual real estate corresponding to the selected region is selected through the user terminal, and enabling the server computer to change and store ownership information on the virtual real estate, if it is verified that the purchasing price of the virtual real estate is paid; and
(e) transmitting a purchase decision message, for which terms and conditions are prescribed, to the owner's terminal, if the owner exists for the selected region, and enabling the server computer to change and store the ownership information of the virtual real estate, if the owner agrees to the terms and conditions sent from a buyer who desires to purchase the properties and it is verified that a sales price prescribed in the transfer agreement is paid.

12. The recording media of claim 11, wherein the (d) comprises:
determining whether the selected region is a non-transaction region and a minimum sales unit region is selected, if the owner does not exist;
selecting a region and a property size again, if the selected region is a non-transaction region or below a minimum unit region;
displaying the property size and sales price of the selected region on the user terminal, if the region is not a non-transaction region and above the minimum sales unit, and transmitting the sales price and payment technique to the user terminal, if the purchase of the virtual real estate corresponding to the selected region is selected through the user terminal; and
enabling the server computer to change and store ownership information of the virtual real estate, if it is verified that the purchasing price of the virtual real estate is paid.

13. The recording media of claim 12, further comprising: selecting a region and a property size again, if the payment for buying the virtual real estate is not performed.

14. The recording media of claim 11, wherein the (e) comprises:
transmitting a purchase decision message, for which terms and conditions are prescribed, to the owner's terminal, if the owner exists for the selected region;
transmitting a new message for terms and conditions to a terminal of a buyer who desires to purchase the property, if the owner does not agree on the terms and conditions;
transmitting a transfer agreement to the buyer's terminal and the server computer, if the owner agrees to the terms and conditions; and
notifying the owner's terminal and the buyer's terminal of the payment, if it is verified that the sales amount of money prescribed in the transfer agreement is paid, enabling an amount of money, except pre-specified sales commissions, to be sent to an account or with a payment technique that the owner desires, enabling the server computer to change and store ownership information of the virtual real estate, and notifying the buyer of changed contents of the ownership information.

15. The recording media of claim 14, further comprises:
notifying the owner's terminal and the buyer's terminal of nonpayment, if it is verified that the buyer does not pay the amount of money, even after the regular time has be passed since the transfer agreement is received from the owner; and
stopping the transaction according to the owner's desire, in case of nonpayment, and transmitting information on the buyer as feedback information on bad buyer for tracking community input on historical transaction experiences to the server computer.

16. The recording media of claim 11, further comprising: editing and storing information on properties, so as to display the text that the user desires, when the user moves a cursor over the virtual real estate by connecting the server computer through the user terminal, if the administration for virtual real estate is desired.

17. The recording media of claim 11, further comprising: outputting a user-specified web page or a blog, when a region on the digital map, on which the virtual real estate is located, is clicked.

18. The recording media of claim 11, further comprising: providing a virtual item through the server computer, so as to enable the virtual item to be purchased through the user terminal, for the purpose of enhancing a value of virtual real estate and decorating the real estate for further personalization and enjoyment.

19. The recording media of claim 11, further comprising: registering the virtual real estate as real estate for sale in a region where the virtual real estate is located, if the owner of the virtual real estate desires to sell the virtual real estate.
